(19) United States
(12) Patent Application Publication
(10) Pub. No.: US 2010/0051663 A1
(43) Pub. Date: Mar. 4, 2010

(54) DEVICES AND METHODS FOR A MOTORCYCLE DRINK HOLDER

(76) Inventor: James R. CARPENTER, Shawnee, KS (US)

Correspondence Address: Adam S. Langley, 1132 Pine Hill Rd., McLean, VA, 22101, US

(21) Appl. No.: 12/552,260

(22) Filed: Sep. 1, 2009

Related U.S. Application Data
(60) Provisional application No. 61/093,959, filed on Sep. 3, 2008.

(51) Int. Cl. B62J 11/00

(52) U.S. Cl. 224/413

(57) ABSTRACT

Devices and methods are disclosed which relate to a drink holder for a motorcycle. A mounting member attaches to a down tube of a motorcycle frame at a first end, and fixedly attaches to a drink holding member at a second end. The mounting member can be fixedly or removably attached to the down tube of a motorcycle frame, and has rotational corrections to ensure the drink is held upright. The drink holding member comprises a cavity for holding a substantially cylindrical drink container and a beverage inside.

### CLAIM FOR PRIORITY

This application claims the benefit of provisional application 61/093,959, which is hereby incorporated by reference in its entirety.

### BACKGROUND OF THE INVENTION

1. Field of the Invention

The present invention relates to drink holders for motorcycles. More specifically the present invention relates to attaching a drink holder to the frame of a motorcycle.

2. Background of the Invention

Today there are many motorcycles on the road. Since the invention of the motorcycle in 1885 many have found motorcycles a means of transportation, sport, show, and other endeavors. From small and lightweight motorcycles used in sports for speed and stunts to large and powerful motorcycles used for traveling distances, motorcycles come in many different forms and encompass activities shared across the world.

Many use motorcycles for everyday transportation. In the summertime the motorcycle can be seen as the ultimate convertible. Having little exterior paneling the breeze is allowed to flow across virtually the entire body. When compared to an automobile, the relatively compact size of a motorcycle allows for easier parking in metropolitan areas. Motorcycles are much more agile than automobiles as well, due to their lighter weight and in-line wheel design. In California, motorcyclists are allowed to travel in between the lanes of traffic, which comes in handy during rush hour when the rest of traffic comes to a stop. The idea of not having to slow down when traffic gets bad makes motorcycles an extremely attractive alternative to an automobile.

As the price in petroleum keeps rising many find themselves searching for more fuel efficient means of transportation. While automobile manufacturers design engines that run on ethanol, biodiesel fuel, electricity, and even hybrids, motorcycles, by their lightweight nature, are much more fuel efficient than any automobile. It is common for motorcycles to range between forty and sixty miles-per-gallon, and it has been that way for years now. Some motorcycles are specifically tuned to enjoy an even higher gas-mileage rating.

Others use motorcycles for sport. Sport motorcycles are nearly all fast and lightweight. Some are equipped with fat tires with large tread for traction in the mud. Large dirt courses are constructed where motorcyclists race across hills and around sharp turns. Courses are constructed in a similar manner but used solely for stunt competitions. As most of these stunts are aerial the courses consist of large ramps resulting in the long hang time necessary for a well-executed stunt. A few motorcyclists make a living doing nothing but stunts. These motorcyclists do not even compete with other motorcyclists, but simply attempt elaborate and seemingly impossible feats in order to draw large crowds which cheer wildly upon completion of the stunt. Of course there are also track motorcycle races which are closer related to an automobile racing event than dirt bike races. Though a lighter weight vehicle is desirable, these motorcycles do not sacrifice power and acceleration for a lighter weight. Few tricks and stunts are employed as these races are about skill, concentration, and determination.

Then there are those motorcycle enthusiasts that enjoy traveling long distances on their motorcycles. They typically employ larger motorcycles tuned for a smoother ride. These motorcycles come with larger fuel tanks so that the rider doesn't need to stop for fuel as often. Large bins may be attached to either side of the seat on these motorcycles, known as saddlebags. Saddlebags come in handy for the distance motorcyclist to hold belongings, food, etc. They can be made from leather or vinyl. Some saddlebags are made from fiberglass or polyvinylchloride (PVC) and are constructed by the manufacturer as part of the body of the motorcycle. A glove box can be found near the front for smaller personal items. A few motorcycles exist with another passenger hold known as a side car which looks a little like a small chariot attached to the rear side of a motorcycle. The addition of a side car makes the motorcycle a three-wheeled vehicle, with the third wheel holding up the far side of the side car. A side car motorcycle may be a little less agile, but can make a more comfortable ride for a passenger traveling long distances.

Motorcycle enthusiasts also enjoy assembling at large events for motorcyclists. These events can be found across the United States and many other countries. Massive conventions are held where motorcyclists meet to display the latest technology, sell their latest products, exchange ideas and techniques, and, of course, to show off their own motorcycles. Some of the most aesthetically pleasing motorcycles appear at these events. Many of the enthusiasts present at these events must travel long distances before arriving. Some have large trucks pulling covered trailers which store their motorcycles, but many don't have that luxury and ride the whole distance. Many of these enthusiasts are the same that enjoy traveling long distances on their motorcycles, but also have an interest in keeping their motorcycle aesthetically pleasing.

Aesthetics and convenience often clash. Motorcycles, even long distance cruisers, are small when compared to any other long distance vehicle, and have little room for cargo holds. The saddle bags and glove boxes are still no comparison to the size of a trunk of an automobile, but are carefully constructed to as not to detract from the overall appearance of the motorcycle. Still there is little innovation when it comes to holding a drink while riding a motorcycle. Studies have shown that a drink holder or amount thereof can rank very high among consumers when purchasing an automobile, yet there are very options for a motorcyclist.

A few aftermarket drink holders are made which clamp onto the handlebars of a motorcycle. This would seem like an ideal placement, but it has its drawbacks. The drink holder can get in the way of a motorcyclists vision and movements. Access to switches can become awkward and important gauges can be hidden. A motorcyclist's view of the road is encroached and all of these problems increase when the drink holder is actually holding a drink. The handlebars and front wheel, which govern the direction of the motorcycle, experience more motion due to turning back and forth than the rest of the body of the motorcycle. Having a drink mounted to the handlebars increases the risk of spills.

When it comes to aesthetics, a drink holder is not the most flattering accessory to have on your motorcycle. Many drink holders are large plastic canisters which can seem a little out of place when perched upon a shining flow of steel, custom paint, and leather.

What is needed in the art is a drink holder for a motorcycle that does not inhibit the rider's vision or access to controls. A drink holder for a motorcycle needs to be in a position where it is not prone to spills. Finally, a drink holder for a motorcycle should not take away from the aesthetic appeal of the motorcycle.

### SUMMARY OF THE INVENTION

The present invention is a mounting member which attaches to a down tube of a motorcycle frame at a first end, and fixedly attaches to a drink holding member at a second end. The mounting member can be fixedly or removably attached to the down tube of a motorcycle frame, and has rotational corrections to ensure the drink is held upright. The drink holding member comprises a cavity for holding a substantially cylindrical drink container and a beverage inside.

In one embodiment the present invention is a drink holder for a motorcycle comprising a drink holding member having a cavity and an attachment member, and a mounting member having a first end attached to the attachment member and a second end attached to the down tube of a motorcycle. The mounting member fixes the drink holding member so that the cavity opens upward.

In another embodiment the present invention is a drink holder for a motorcycle comprising a hollow cylindrical member having a closed end, an open end, and an outer wall, and an elongate member having a first end attached to the outer wall of the cylindrical member and a second end attached to the down tube of a motorcycle. The elongate member fixes the cylindrical member so that the open end faces upward.

In yet another embodiment the present invention is a method of holding a drink on a motorcycle comprising attaching a mounting member to a down tube of a motorcycle, and fixing a drink holding member to the mounting member. The mounting member fixes the drink holding member so that a drink may be held substantially upright when inserted into the drink holding member.

### BRIEF DESCRIPTION OF THE DRAWINGS

FIG. 1A shows a side view of a drink holder for a motorcycle according to an exemplary embodiment of the present invention.

FIG. 1B shows a bottom view of a drink holder for a motorcycle according to an exemplary embodiment of the present invention.

FIG. 1C shows a front view of a drink holder for a motorcycle according to an exemplary embodiment of the present invention.

FIG. 2 shows a sample motorcycle frame with two down tubes.

FIG. 3A shows a side view of a motorcycle frame with a drink holder attached to the down tube according to an exemplary embodiment of the present invention.

FIG. 3B shows a front view of a drink holder for a motorcycle attached to a down tube of a motorcycle frame according to an exemplary embodiment of the present invention.

FIG. 4A shows a side view of a drink holder for a motorcycle highlighting a nut and bolt attachment according to an exemplary embodiment of the present invention.

FIG. 4B shows a mounting member attached to a down tube according to an exemplary embodiment of the present invention.

FIG. 4C shows a mounting member attached to a down tube according to an exemplary embodiment of the present invention.

FIG. 5A shows a side view of a drink shield according to an exemplary embodiment of the present invention.

FIG. 5B shows a front view of a drink shield according to an exemplary embodiment of the present invention.

### DETAILED DESCRIPTION OF THE INVENTION

The present invention is a mounting member which attaches to a down tube of a motorcycle frame at a first end, and fixedly attaches to a drink holding member at a second end. The mounting member can be fixedly or removably attached to the down tube of a motorcycle frame, and has rotational corrections to ensure the drink is held upright. The drink holding member comprises a cavity for holding a substantially cylindrical drink container and a beverage inside.

“Down tube”, as used herein and throughout in this disclosure, refers to the tubes of a motorcycle frame that extend from the steering column angled in a downward direction until it meets the bottom of the motorcycle frame. In FIG. 2 the down tube is labeled 220. Most motorcycle frames have two down tubes, one on each side, but some newer models have a single down tube.

“Drink”, as used in this disclosure, refers to a liquid beverage and its container. Most any substantially cylindrical container fits within the scope of this disclosure. Examples of a drink include a can of soda, a bottle of water, a sports drink in a plastic bottle, a mug of coffee, a squirt bottle having liquid, a paper cup having liquid, etc.

For the following description, it can be assumed that most correspondingly labeled structures across the figures (e.g., 312 and 412, etc.) possess the same characteristics and are subject to the same structure and function. If there is a difference between correspondingly labeled elements that is not pointed out, and this difference results in a non-corresponding structure or function of an element for a particular embodiment, then that conflicting description given for that particular embodiment shall govern.

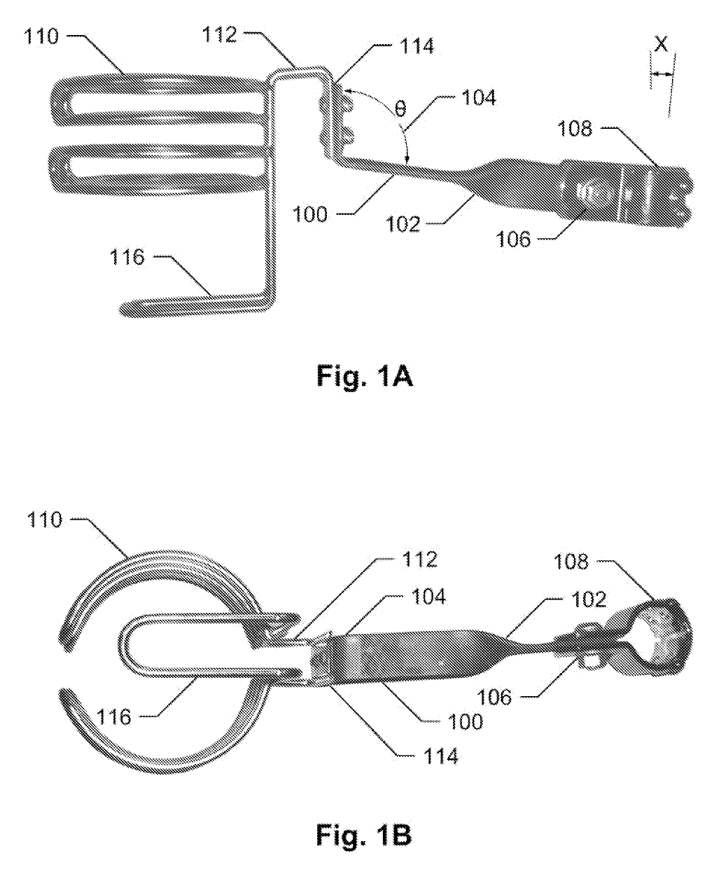

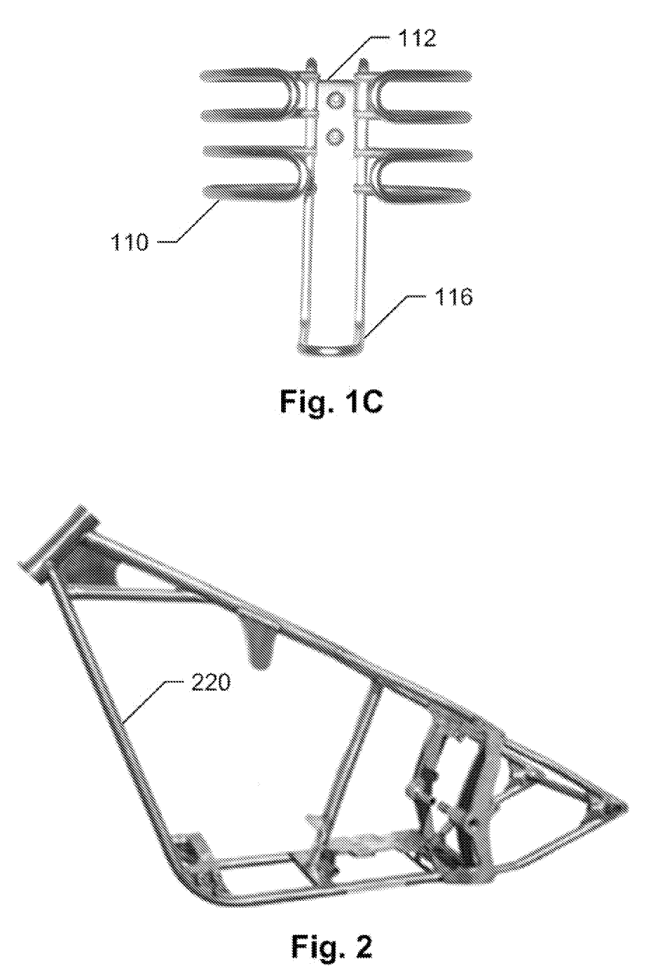

An exemplary embodiment of the present invention, shown in FIGS. 1A, 1B, and 1C, features a mounting member 100 and drink holding member 110. Mounting member 100 comprises clamping member 108, locking member 106, rotational correcting twist 102, and rotational correcting bend 104. Clamping member 108 attaches securely to a down tube of a motorcycle. Different views are used in this figure to better demonstrate certain features. In this embodiment, clamping member 108 forms a circular clamp which fits around the down tube of a motorcycle. Once clamping member 108 is around the down tube at the desired point, locking member 106 is tightened to fasten clamping member 108 in place. In this embodiment, locking member 106 is also used to fasten clamping member 108 to the rest of mounting member 100. Rotational correcting twist 102 is a twist in mounting member 100 which corrects the angle of the drink holder. In this embodiment mounting member must be twisted about ninety degrees in order for the drink to be held upright. Rotational correcting bend 104 has much the same function as rotational correcting twist, but corrects for a different angle, θ, which is best shown in FIG. 1A. If the down tube has an angle X, then θ can be solved for using the formula:

θ=X+90

where X and ninety (90) are in degrees. Drink holding member 110 forms a cavity which surrounds a drink and further comprises closed end 116, attachment member 112, and attachment 114. In this embodiment drink holding member 110 forms a substantially open cavity. The metal tubes comprising drink holding member in this embodiment display a substantially minimum amount of material necessary to hold a drink. A drink can be inserted through the top of drink holding member 110, as viewed in FIG. 1A. The circular metal bars toward the top of drink holding member 110 guide the drink as the user lowers it until closed end 116 stops it. Closed end 116, best viewed in FIG. 1B, is a tab or shelf of metal bars just large enough to support a drink and preferably extending at least to the center of drink holding member 110. Attachment member 112 comes off the side of drink holding member 110 near the top. In this embodiment, attachment member 112 is made of the same metal as the rest of drink holding member 110. Attachment member 112 comes off substantially horizontal at first then takes a bend downward where it attaches to mounting member 100 at rotational correcting bend 104.

The clamping member attaches to the down tube preferably in a non destructive fashion such as in FIG. 1. However, other embodiments include gluing and/or bolting the clamping member to the down tube so that the attachment is more secure. The locking member has many variations and can be removably attached to the mounting member so that the drink holder can be removed for show. When removed, all that is left attached to the motorcycle is the clamping member and the locking member. The clamping member is made from a solid material capable of withstanding the force necessary to clamp it to the down tube without sliding. Depending on the model of motorcycle used the clamping member may need to withstand higher temperatures. Metals such as steel, copper, brass, etc. can be used as well as durable plastics and ceramics. Other suitable metals and materials will be readily recognizable to one skilled in the art. Embodiments of the clamping member include a chrome finish for aesthetics.

The mounting member is shown as coming substantially straight out from the down tube with two rotational corrections built into it. Some motorcycles inhibit the mounting member from coming straight out due to engine parts or other motorcycle parts held in the way. To accommodate these obstacles the mounting member can be elongated and bent so that the mounting member weaves around these obstacles. The placement of the rotational corrections varies among embodiments. Multiple rotational corrections may need to be used in weaving embodiments. One of ordinary skill in that art will recognize that rotational corrections should be used to orient the drink holding member in a substantially upright position. The mounting member requires substantially the same strength and heat resistance qualities as the clamping member. The mounting member must be strong enough to hold a full beverage, which most likely will not exceed four pounds, upright and in a stationary position with respect to the motorcycle. Metals such as steel, copper, brass, titanium, etc. and their alloys can be used as well as durable plastics, ceramics, carbon fiber, etc. Other suitable metals and materials will be readily recognizable to one skilled in the art.

There are many embodiments of the drink holding member. The drink holding member includes a substantially cylindrical hollow body that is closed at one end. The cylinder walls can be solid, contain holes, or be in the form of a mere wire outline such as in FIG. 1. The cylinder walls substantially surround the circumference of the drink and hold it upright. The closed end of the cylinder holds the bottom of the drink to keep it from falling through the cylinder walls. The drink holding member can be made from a larger variety of materials than the clamping and mounting members. The drink holding member is not under as much stress as the clamping and mounting members. Motorcycle frames and engine layouts vary but in most cases the drink holding member is farther away than the clamping and mounting members and does not absorb as much heat. The drink holding member can also be made from any materials that the clamping and mounting members are made.

A sample of a motorcycle frame is shown in FIG. 2. The down tube of the motorcycle frame is labeled 220. The placement of the drink holder on down tube 220 varies with user preference. Attached to the down tube the drink holder and the drink are below the gauge cluster and out of user's view of the road. Most motorcycles have two down tubes, but some models have only one. In the case of a single down tube the mounting member may need to wind around engine parts before terminating at the drink holding member. A longer mounting member may be required in these cases. Certain embodiments of the drink holder feature an extendable mounting member.

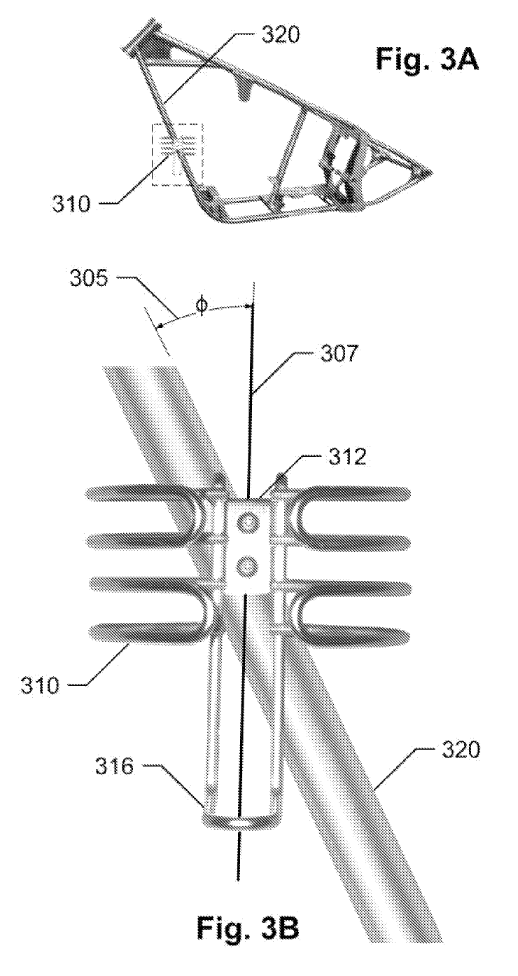

FIGS. 3A and 3B show an exemplary embodiment of a drink holding member 310 attached to the down tube 320 of a motorcycle frame. In FIG. 3B, angle φ 305, formed by the rotational correcting twist, is shown. Down tube 320 of the motorcycle frame extends downward at a slight angle. Rotational correcting twist ensures that drink holding member 310 is fixed in a substantially upright position. Angle φ 305 is conveniently equal to the exact opposite of the angular displacement of down tube 320 from a vertical axis 307. In other words if down tube 320 is perfectly vertical, then angle φ 305 is zero. If down tube 320 is off of the vertical by thirty degrees, then rotational correcting twist must be rotated in the opposite direction thirty degrees.

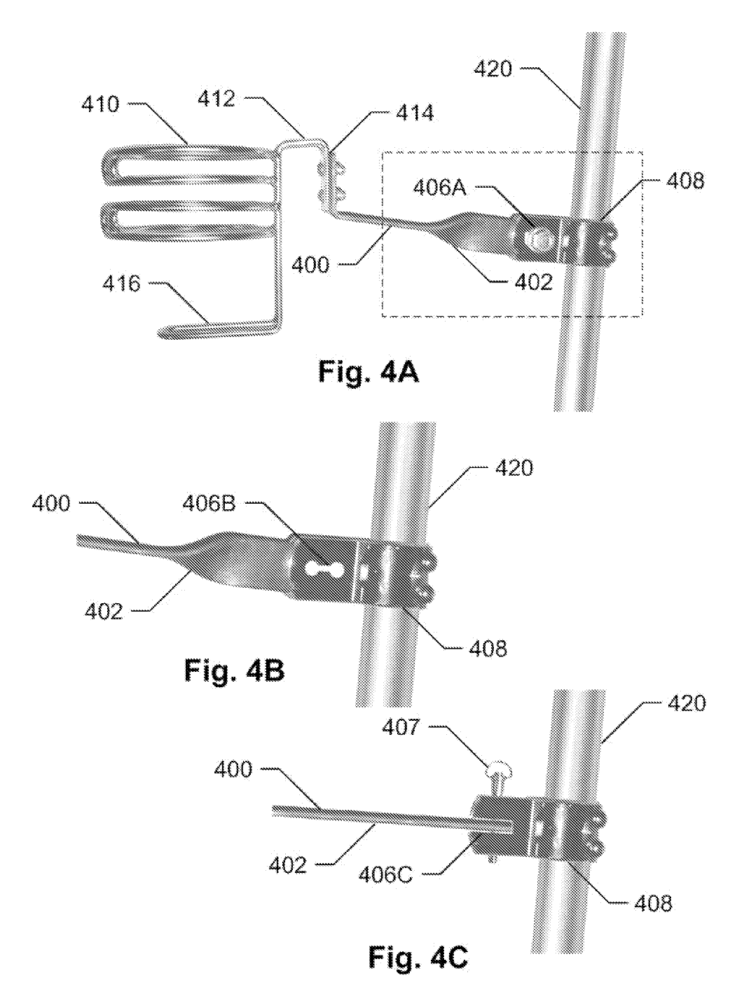

Exemplary embodiments of the locking member are shown in FIGS. 4A, 4B, and 4C. FIG. 4A shows a conventional nut and bolt 406A. The bolt goes through holes in either side of clamping member 408 and mounting member 400. This embodiment of the locking member is a more permanent solution for a drink holder. The nut and bolt 406A must be unfastened before removal of the drink holder. When the user desires to have the drink holder attached again the nut and bolt 406A must be securely fastened so that there is no movement of mounting member 400 relative to the clamping member 408. Other embodiments show a more removable locking member. FIG. 4B shows a keyhole 406B through either side of clamping member 408 and mounting member 400. With this locking member an elongate key with a cross-sectional area of the same shape as keyhole 406B is used to lock mounting member 400 into place. Since the design of keyhole 406B is not circular, movement of mounting member 400 with respect to clamping member 408 is kept to a minimum by simply inserting the elongate key. Mounting member 400 can be detached from clamping member 408 by removing the elongate key. FIG. 4C shows yet another embodiment of a removable locking member. Mounting member 400 slidably engages with clamping member 408 similarly to the previous embodiment, but oriented differently. Locking member 406C holds mounting member 400 so that elongate key 407 is inserted vertically. With this orientation rotational correcting twist 402 is substantially lessened. Many other methods of removably connecting mounting member 400 to clamping member 408 are recognizable by one skilled in the art.

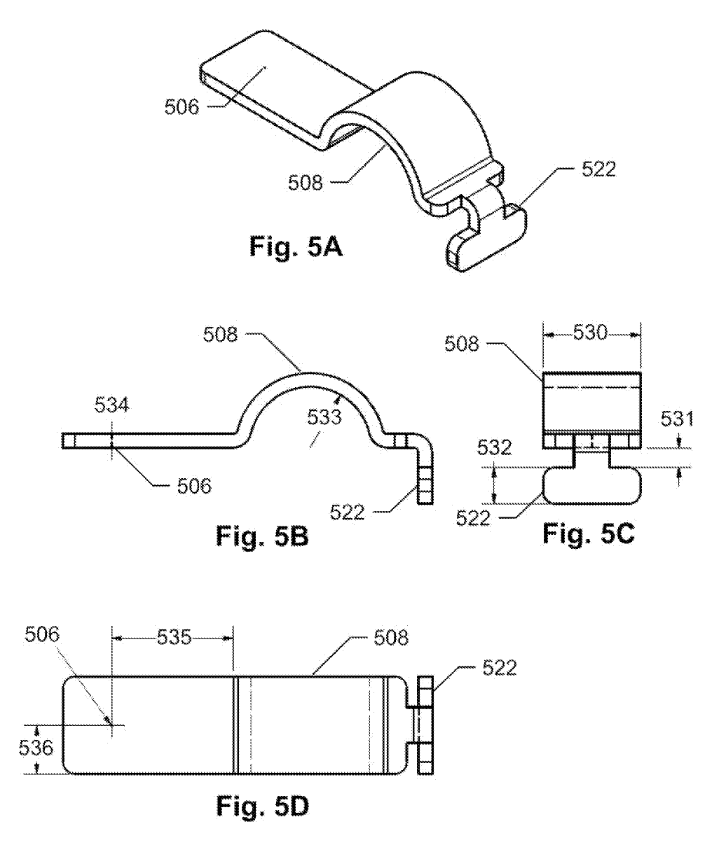

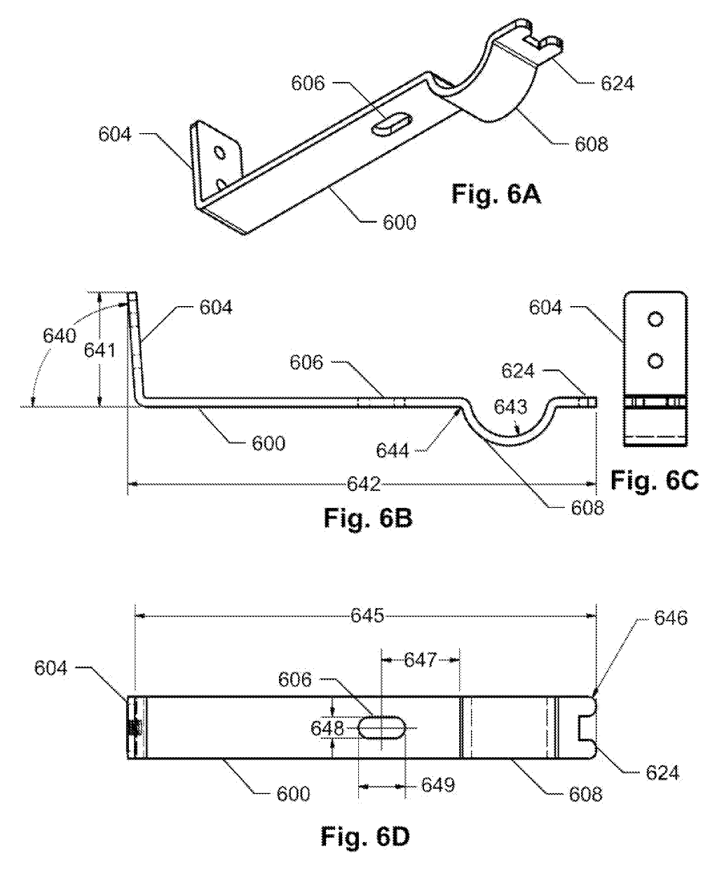

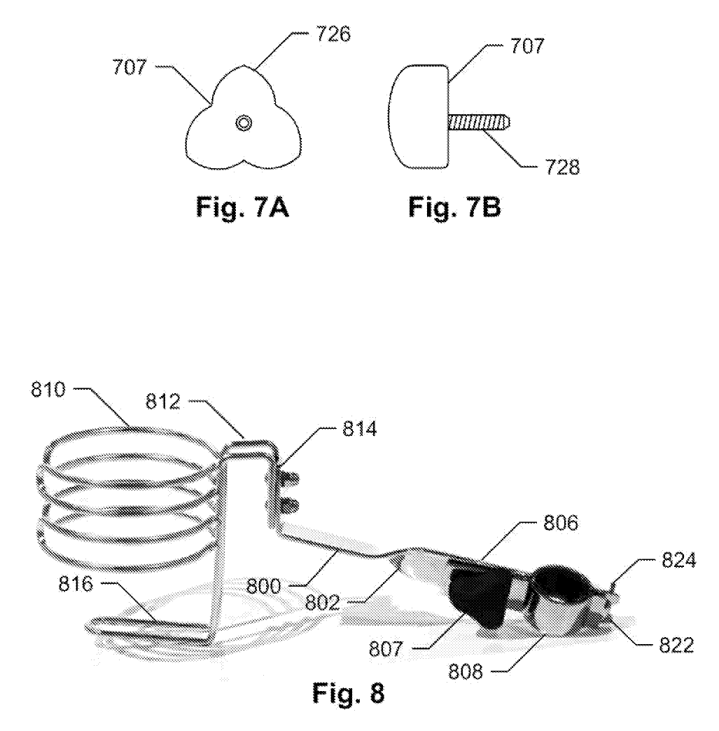

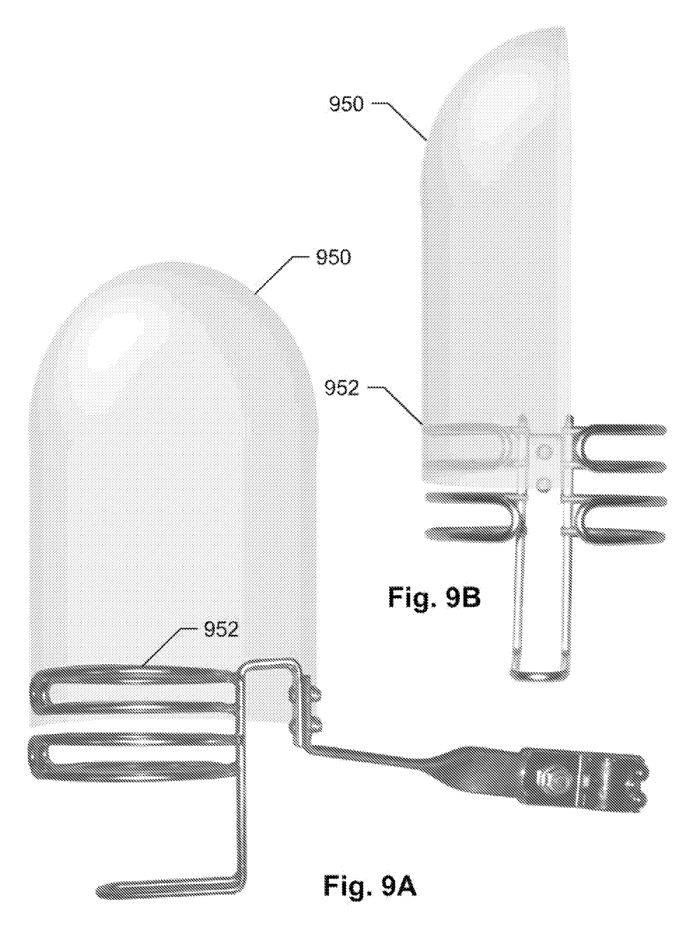

FIGS. 5 and 6 show a clamping member for a mounting member, according to another exemplary embodiment of the present invention. FIG. 5A shows a perspective view of a clamping member 508 having a bolt receiving throughbore 506 and a clamping head 522. Bolt receiving throughbore has threading inside to match the outer threading of a bolt. FIG. 5B shows a side view of clamping member 508 and measurements 533 and 534. In this exemplary embodiment 533 is a radius of curvature of 0.625 in. and 534 is a thickness of 0.141 in. FIG. 5C shows a front view of clamping member 508 measurements 530-532. In this exemplary embodiment 530 is a width of 1 in., 531 is a spacing of 0.375 in., and 532 is a width of 0.201 in. FIG. 5D shows a top view of clamping member 508 and measurements 535 and 536. In this exemplary embodiment 535 is a distance of 1.25 in. and 536 is a distance of 0.5 in.

FIG. 6 shows a mounting member having a clamping member complimentary to the clamping member of FIG. 5, according to an exemplary embodiment of the present invention. FIG. 6A shows a mounting member 600 having a complimentary clamping member 608, an aperture 606, a rotational correcting bend 604, and a clamping slot 624. Clamping slot 624 receives clamping head 522 as clamping members 508 and 608 form a complete loop around a down tube. Aperture 606 aligns with bolt receiving throughbore 506 where a bolt is inserted first through aperture 606 then into bolt receiving throughbore 506 where it fastens to mounting member 600. In this configuration, the union of clamping slot 624 and clamping head 522 holds clamping members 508 and 608 together on one side while the bolt fastening mounting member at aperture 606 to clamping member 508 at bolt receiving throughbore 506 holds clamping members 508 and 608 together on the other side. Though mounting member 600 is not showing a rotational correcting twist, one can be implemented to ensure a drink is held upright. FIG. 6B shows a side view of mounting member 600 and measurements 640-644. In this exemplary embodiment 640 is an angle of eighty-six (86) degrees, 641 is a distance of 1.839 in., 642 is a distance of 7.524 in., 643 is a radius of curvature of 0.625 in., and 644 is a radius of curvature of 0.047 in. FIG. 6C shows a front view of mounting member 600. FIG. 6D shows a top view of mounting member 600 and measurements 645-659. In this exemplary embodiment, 645 is a length of 7.408 in., 646 is a radius of curvature of 0.125 in., 647 is a distance of 1.25 in., 648 is a width of 0.344 in., and 649 is a length of 0.75 in.

FIGS. 7A and 7B show a hand bolt 707 to fasten a mounting member and a clamping member, according to an exemplary embodiment of the present invention. FIG. 7A shows a bottom view of hand bolt 707 having a large head 726 for hand tightening. FIG. 7B shows a side view of hand bolt 707 having an elongate threaded member 728. Threaded member 728 has outer threading to grip the inside of a bolt receiving throughbore. Head 726 has an uneven radius about threaded member 728 for increased gripping and rotating ability. Head 726 can be made from any materials that the drink holding member is made from. In other embodiments head 726 has a rubber coating for increased gripping.

FIG. 8 shows a drink holder for a motorcycle having a mounting member 800 and a drink holding member 810, according to another exemplary embodiment of the present invention. The clamping assembly of mounting member 800 is similar to that of FIGS. 5 and 6. A hand bolt 807 similar to that of FIG. 7 is shown fastening clamping member 808 to mounting member 800. A clamping head 822, similar to that of FIG. 5, is held inside a clamping slot 824, similar to that of FIG. 6.

Further complimenting embodiments of the present invention is a drink shield. The drink shield prevents open containers from collecting debris as the motorcycle is driven. The drink shield comprises a barrier partially enclosing a volume just above the drink holding member. The barrier separates this volume from the atmosphere on all sides except the bottom and the side which is oriented toward the rear of the motorcycle. The bottom of the barrier attaches near the top of the drink holding member. The barrier is open at the bottom so that a drink may be placed in the drink holding member. Depending on the height of the drink the barrier may need to be taller or shorter. Drink shields with a taller barrier can accommodate more drink sizes than drink shields with shorter barriers. The drink shield is made from any material that can stand under its own strength and withstand the wind resistance of the motorcycle at high speed. Materials such as plastics, ceramics, PVC, metals, etc. can be used to make the barrier. The drink shield may removably or fixedly attach to the drink holding member near the bottom. The attachment must be strong enough to withstand the wind resistance of the motorcycle at high speed. The drink shield can fixedly attach to the drink holding member using adhesives or fasteners such as glue, tape, screws, nails, rivets, clamps, etc. In some embodiments the drink shield and the drink holding member are one piece made from the same material. The drink shield can removably attach to the drink holding member using snaps, hook-and-loop fasteners, removable adhesive, etc.

FIG. 9 shows a drink shield for a drink holding member according to an exemplary embodiment of the present invention. The drink holding member comprises a barrier 950 and an attachment 952. Barrier 950 encompasses a volume roughly twice the height of the drink holding member. The center of barrier 950 is on the side of the drink holding member which is oriented toward the front of the motorcycle. From there barrier 950 extends around the circumference of the drink holding member until about half of the drink holding member is enclosed. Barrier 950 is made from a translucent material and is rounded at the top. The bottom of barrier 950 is glued to the top rungs of the metal wire that makes up the drink holding member.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A drink holder for a motorcycle comprising:
A drink holding member having a cavity and an attachment member; and
A mounting member having a first end attached to the attachment member and a second end attached to the down tube of a motorcycle;
wherein the mounting member fixes the drink holding member so that the cavity opens upward.

2. The device in claim 1, wherein the drink holding member is made from one of steel, copper, brass, titanium, plastics, ceramics, and carbon fiber.

3. The device in claim 1, wherein the drink holding member comprises a wire frame.

4. The device in claim 1, wherein the mounting member is made from one of steel, copper, brass, titanium, durable plastics, ceramics, and carbon fiber.

5. The device in claim 1, wherein the mounting member comprises at least one rotational correction.

6. The device in claim 5, wherein the rotational correction is a twist in the mounting member.

7. The device in claim 5, wherein the rotational correction is a bend in the mounting member.

8. The device in claim 1, wherein the mounting member attachment to the down tube is a releasable attachment.

9. The device in claim 9, wherein the releasable attachment includes a clamping head and a clamping slot.

10. A drink holder for a motorcycle comprising:
A hollow cylindrical member having a closed end, an open end, and an outer wall; and
An elongate member having a first end attached to the outer wall of the cylindrical member and a second end attached to the down tube of a motorcycle;
wherein the elongate member fixes the cylindrical member so that the open end faces upward.

11. The device in claim 10, wherein the hollow cylindrical member is made from one of steel, copper, brass, titanium, plastics, ceramics, and carbon fiber.

12. The device in claim 10, wherein the hollow cylindrical member comprises a wire frame.

13. The device in claim 10, wherein the elongate member is made from one of steel, copper, brass, titanium, durable plastics, ceramics, and carbon fiber.

14. The device in claim 10, wherein the elongate member comprises at least one rotational correction.

15. The device in claim 14, wherein the rotational correction is a twist in the mounting member.

16. The device in claim 14, wherein the rotational correction is a bend in the mounting member.

17. The device in claim 10, wherein the elongate member attachment to the down tube is a releasable attachment.

18. The device in claim 17, wherein the releasable attachment includes a clamping head and a clamping slot.

19. A method of holding a drink on a motorcycle comprising:
attaching a mounting member to a down tube of a motorcycle; and
fixing a drink holding member to the mounting member;
wherein the mounting member fixes the drink holding member so that a drink may be held substantially upright when inserted into the drink holding member.

20. The method in claim 19, wherein the attaching comprises releasably attaching the mounting member to the down tube of a motorcycle.

21. The method in claim 19, further comprising bending the mounting member to correct the orientation of the drink.

22. The method in claim 19, further comprising twisting the mounting member to correct the orientation of the drink.
